(19) United States
(12) Patent Application Publication
(10) Pub. No.: US 2026/0278613 A1
(43) Pub. Date: Sep. 17, 2026

(54) METADATA-DRIVEN AUTOMATED FRAUD TREND DETECTION AND RISK RULES GENERATION FOR ONLINE TRANSACTIONS

(71) Applicant: eBay Inc., San Jose, CA (US)

(72) Inventors: Bing WANG, Shanghai (CN); Jianan HU, Shanghai (CN); Junhao GAO, Shanghai (CN); Mei LI, Shanghai (CN); Yao WEI, Shanghai (CN); Shu FAN, Shanghai (CN); Weiming LIANG, Shanghai (CN); Cheng LAN, Shanghai (CN); Yinan SHAN, Shanghai (CN); Xin LI, Shanghai (CN); Qiang WANG, Shanghai (CN)

(21) Appl. No.: 19/077,725

(22) Filed: Mar. 12, 2025

(51) Int. Cl. G06Q 20/40

(52) U.S. Cl. CPC G06Q 20/4016

(57) ABSTRACT

Some aspects relate to technologies for leveraging metadata to automatically detect fraudulent trends in online transactions and to generate risk rules based on the fraudulent trends. In accordance with some aspects, event data related to online transactions on an online transaction platform is collected. The event data is collected and enriched using a first set of metadata from a metadata store to provide enriched data. A fraudulent trend is detected by analyzing the enriched data using one or more clustering and/or predictive algorithms guided by a second set of metadata from the metadata store. A risk rule is then generated based on the fraudulent trend using a third set of metadata from the metadata store. The risk rule is deployed to an online fraud detection system to identify fraudulent transactions on the online transaction platform.

### BACKGROUND

In recent years, financial frauds using online transaction platforms (e.g., e-commerce, payment, banking, and other systems that support online transactions) have attracted widespread attention, including but not limited to credit card fraud, insurance fraud, money laundering, healthcare fraud, securities, and commodity fraud. At the same time, as the number of online transactions using such platforms increases, fraudulent activities are growing at an astonishing rate, with worldwide losses caused by financial fraud up to billions of dollars each year. These fraudulent activities may disrupt economic stability, increase living costs, cause societal incident, and reduce consumer trust in online transaction platforms. For example, in e-commerce platforms, fraudulent accounts use stolen payment accounts to conduct bulk purchases, frequent orders, false refunds, and other improper behaviors, affecting the normal operation of the platforms and causing victim merchants and consumers to suffer losses. Meanwhile, some fraudulent accounts are disguised by robots to steal users' private information, resulting in serious damage to the platform's reputation. Since the consequences of fraudulent activities in online transaction platforms are devastating, developing methods and technologies to detect and identify frauds is of great importance.

### SUMMARY

Some aspects of the present technology relate to, among other things, a metadata-driven system for automatically detecting fraudulent trends in online transactions and generating risk rules for a fraud detection system based on the fraudulent trends. The system leverages metadata from a metadata store to automatically collect and enrich event data from online transaction platforms, identify fraudulent trends using clustering and predictive algorithms, and generate risk rules based on these trends. The generated risk rules are then deployed to an online fraud detection system to identify and mitigate fraudulent activities in real-time or near real-time.

In accordance with some aspects, event data related to online transactions is initially collected and enriched using a first set of metadata from a metadata store. This metadata specifies the types of event data to collect and how to process and manage the data, ensuring it is enriched with relevant information for subsequent analysis. The enriched event data is analyzed to detect fraudulent trends using a second set of metadata from the metadata store. This can involve identifying abnormal and normal transactions based on predefined definitions and applying clustering and predictive algorithms to detect patterns indicative of fraud. Based on the detected fraudulent trends, risk rules are generated using a third set of metadata from the metadata store. This can involve selecting key variables for rule creation, tuning variable thresholds to maximize decision precision, and simulating the execution of the risk rules to evaluate their performance. The generated risk rules are then deployed to a fraud detection system. In some aspects, the risk rules may be initially deployed in a flagging mode for performance evaluation. If the risk rules meet predefined performance criteria, they are then deployed in an action mode to actively block fraudulent transactions on the online transaction platform.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram showing an example end-to-end pipeline for fraud trend detection and rule generation/deployment in accordance with some implementations of the present disclosure;

FIG. 3 is a block diagram showing an example data collection pipeline in accordance with some implementations of the present disclosure;

FIG. 4 is a block diagram showing an example fraudulent trend detection pipeline in accordance with some implementations of the present disclosure;

FIG. 5 is a block diagram showing an example rule generation pipeline in accordance with some implementations of the present disclosure;

FIG. 6 is a block diagram showing an example rule deployment pipeline in accordance with some implementations of the present disclosure;

FIG. 7 is a flow diagram showing a method for metadata-driven risk rule generation and deployment in accordance with some implementations of the present disclosure; and

FIG. 8 is a block diagram of an exemplary computing environment suitable for use in implementations of the present disclosure.

### DETAILED DESCRIPTION

### Overview

The continued growth of online transaction platforms (including, for instance, e-commerce, payment, and banking systems) presents a particular challenge for identifying and combating fraudulent activity at a level that did not exist before the advent of such online platforms. Conventional fraud detection approaches for online transaction platforms often employ risk rules that are used to evaluate transaction data to identify fraudulent transactions. For instance, transaction data for an online transaction can be provided to a fraud detection system that evaluates the transaction data using the risk rules to determine if the online transaction is fraudulent. These risk rules need to be updated as fraud methods continue to evolve and escalate to evade such conventional fraud detection. In some cases, these risk rules are crafted by policy teams based on comprehensive manual analysis of transaction data. However, the process of designing the risk rules is time-consuming, often taking over a week before they can be deployed in production. During this delay, fraudulent transactions can slip through, resulting in financial losses.

Aspects of the technology described herein improve the fraud detection capabilities of fraud detection systems for online transaction platforms by providing an automated end-to-end process that leverages metadata to drive the detection of fraudulent trends in real-time or near real-time online transactions and to generate/deploy risk rules based on those fraudulent trends. In accordance with some aspects, the automated process includes a series of pipelines that can leverage different metadata from a metadata store. The pipelines include: data collection, fraudulent trend detection, risk rule generation, and risk rule deployment.

The data collection process involves gathering event data related to online transactions and enriching this data using a first set of metadata from a metadata store. This metadata specifies the types of event data to collect and provides guidelines on how to process and manage the data. The enrichment process ensures that the collected data is supplemented with relevant information, making it suitable for subsequent analysis.

Fraudulent trend detection is carried out by analyzing the enriched event data using a second set of metadata from the metadata store. In some aspects, this process involves identifying abnormal and normal transactions based on predefined definitions. Clustering and predictive algorithms are then applied to detect patterns indicative of fraudulent activity. The second set of metadata guides the application of these algorithms, ensuring accurate and efficient detection of fraudulent trends.

Risk rule generation is based on the detected fraudulent trends and utilizes a third set of metadata from the metadata store. In some aspects, this pipeline involves generating risk rules by selecting key variables for rule creation and tuning variable thresholds to maximize decision precision. Some configurations also simulate the execution of the risk rules on a prepared dataset to evaluate their performance before deployment to a production environment. The third set of metadata provides the parameters and guidelines for generating effective risk rules that can accurately identify fraudulent transactions while minimizing false positives.

Risk rules generated based on fraudulent trends are deployed to a fraud detection system. In some configurations, the risk rules are initially deployed in a flagging mode for performance evaluation. During this phase, the system monitors the flagged transactions to assess the effectiveness of the risk rules. If the risk rules meet predefined performance criteria, they are then deployed in an action mode to actively block fraudulent transactions on the online transaction platform. This staged deployment ensures that only validated and effective risk rules are used to mitigate fraudulent activities.

Aspects of the technology described herein provide significant technical advantages in the realm of online transaction fraud detection. By leveraging a metadata-driven approach, the system automates the detection of fraudulent trends and the generation of risk rules, which enhances the efficiency and accuracy of fraud detection processes. The unified metadata store centralizes all essential metadata, facilitating real-time or near real-time data collection, processing, and enrichment. This ensures that the system can quickly adapt to new types of fraudulent activities without requiring time-consuming manual intervention. The metadata store also allows for the dynamic updating of metadata, enabling the system to quickly adjust various aspects of the fraudulent trend detection and risk rule generation processes. Additionally, the automated pipelines for data collection, fraudulent trend detection, rule generation, and rule deployment work in tandem to provide a seamless and dynamic fraud detection mechanism. This reduces the time required to identify and mitigate fraudulent transactions, for instance, from weeks to mere hours, significantly minimizing potential financial losses. Further, the system's ability to simulate and evaluate the performance of generated risk rules before deployment ensures that only effective rules are implemented, thereby maintaining high precision in fraud detection while reducing/preventing false positives. Overall, the technology described herein provides a robust, scalable, and adaptive solution for combating online transaction fraud, enhancing the security and reliability of online transaction platforms.

### Example System for Fraud Detection Using Metadata-Driven Risk Rule Generation

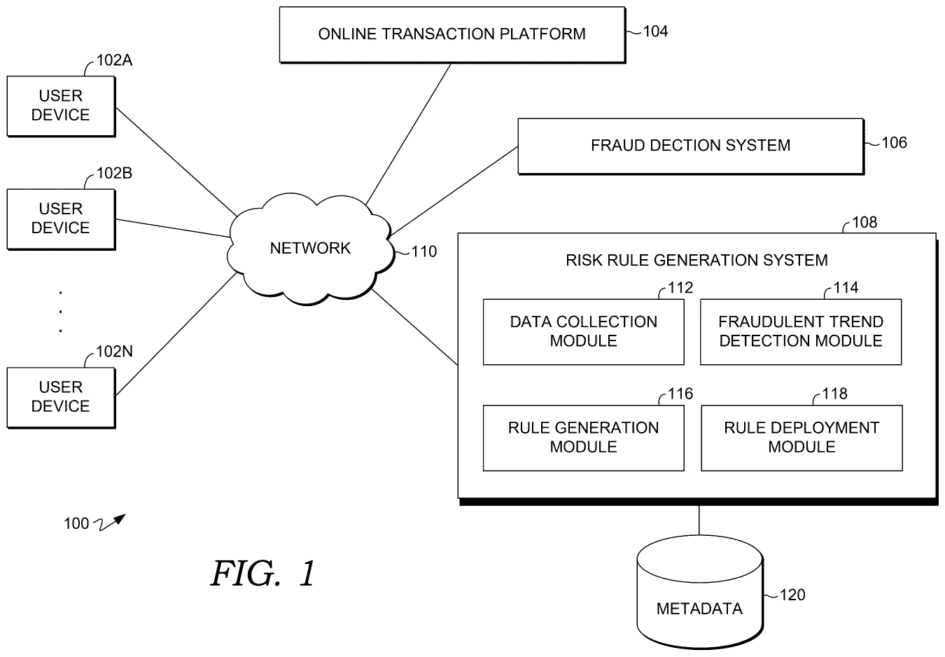

With reference now to the drawings, FIG. 1 is a block diagram illustrating an exemplary system 100 for automatically generating risk rules for detecting fraudulent transactions in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

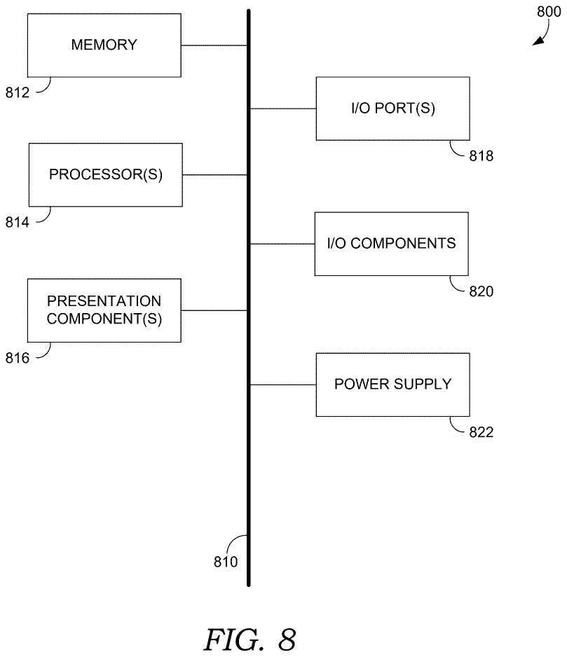

The system 100 is an example of a suitable architecture for implementing certain aspects of the present disclosure. Among other components not shown, the system 100 includes any number of user devices 102A-102N, an online transaction platform 104, a fraud detection system 106, and a risk rule generation system 108. Each of the user devices 102A-102N, the online transaction platform 104, the fraud detection system 106, and the risk rule generation system 108 shown in FIG. 1 can comprise one or more computer devices, such as the computing device 800 of FIG. 8, discussed below. As shown in FIG. 1, the user devices 102A-102N, the online transaction platform 104, the fraud detection system 106, and the risk rule generation system 108 can communicate via a network 110, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the online transaction platform 104, the fraud detection system 106, and/or the risk rule generation system 108 could each be provided by multiple server devices collectively providing the functionality of the online transaction platform 104, the fraud detection system 106 and/or the risk rule generation system 108 as described herein. Additionally, other components not shown may also be included within the network environment.

Each of the user devices 102A-102N can be a client device on the client-side of system 100, while the online transaction platform 104, the fraud detection system 106, and/or the risk rule generation system 108 can be on the server-side of system 100. In some aspects, the online transaction platform 104, the fraud detection system 106, and/or the risk rule generation system 108 can each comprise server-side software designed to work in conjunction with client-side software on the user devices 102A-102N so as to implement any combination of the features and functionalities discussed in the present disclosure. For instance, each of the user devices 102A-102N can include an application (not shown) for interacting with the online transaction platform 104, the fraud detection system 106, and/or the risk rule generation system 108. The application can be, for instance, a web browser or a dedicated application for providing functions, such as interacting with the online transaction platform 104, the fraud detection system 106, and/or the risk rule generation system 108. This division of system 100 is provided to illustrate one example of a suitable environment, and there is no requirement for each implementation that any combination of the online transaction platform 104, the fraud detection system 106, and/or the risk rule generation system 108 remain as separate entities. For instance, in some aspects, the fraud detection system 106 is a part of the online transaction platform 104; and in some aspects, the risk rule generation system 108 is part of the fraud detection system 106. While the system 100 illustrates a configuration in a networked environment with separate user devices, online transaction platform, fraud detection system, and risk rule generation system, it should be understood that other configurations can be employed in which aspects of the various components are combined.

Each of the user devices 102A-102N may comprise any type of computing device capable of use by a user. For example, in one aspect, a user device may be the type of computing device 800 described in relation to FIG. 8 herein. By way of example and not limitation, the user devices 102A-102N may each be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A different user may be associated with each of the user devices 102A-102N and may interact with the online transaction platform 104, the fraud detection system 106, and/or the risk rule generation system 108 via the user devices 102A-102N.

The online transaction platform 104 can be implemented using one or more server devices, one or more platforms with corresponding application programming interfaces, cloud infrastructure, and the like. The online transaction platform 104 generally comprises any computer-based system that facilitates electronic transactions over the network 110 via the user devices 102A-102N. In some aspects, the online transaction platform 104 comprises a listing platform (e.g., an e-commerce platform) that generally provides, to the user devices 102A-102N, item listings describing items (physical or digital) available for purchase, rent, streaming, download, etc., and facilitates electronic purchase transactions for items. In other aspects, the online transaction platform 104 comprises a payment platform that facilitates electronic payment transactions between two accounts. In still further aspects, the online transaction platform 104 comprises a banking platform that facilitates the electronic transfer of money between accounts.

The fraud detection system 106 can also be implemented using one or more server devices, one or more platforms with corresponding application programming interfaces, cloud infrastructure, and the like. The fraud detection system 106 generally comprises any computer-based system that is responsible for detecting fraud in online transactions for the online transaction platform 104. The fraud detection system 106 utilizes risk rules to evaluate transaction data for online transactions to determine a risk of the online transactions being fraudulent. In accordance with aspects of the technology described herein, the fraud detection system 106 employs risk rules that are automatically generated and deployed by the risk rule generation system 108. In some configurations, the fraud detection system 106 can also use risk rules crafted by policy teams based on manual analysis of transaction data from the online transaction platform and/or risk rules from other sources. When the fraud detection system 106 identifies a transaction as fraudulent, a number of actions can be taken, such as, for instance, flagging the fraudulent transaction for an administrative team to review and/or take manual actions, and/or automatically blocking the fraudulent transaction.

As described in further detail below, the risk rule generation system 108 generally provides for the automatic analysis of event data from the online transaction platform 104 and/or the fraud detection system 106 to identify fraudulent trends and to generate and deploy risk rules based on the identified trends. As shown in FIG. 1, the risk rule generation system 108 includes a data collection module 112, a fraudulent trend detection module 114, a rule generation module 116, and a rule deployment module 118. The components/modules of the risk rule generation system 108 may be in addition to other components/modules that provide further additional functions beyond the features described herein. The risk rule generation system 108 can be implemented using one or more server devices, one or more platforms with corresponding application programming interfaces, cloud infrastructure, and the like. While the risk rule generation system 108 is shown separate from the online transaction platform 104 and the fraud detection system 106 in the configuration of FIG. 1, it should be understood that in other configurations, some of the functions of the risk rule generation system 108 can be provided on the online transaction platform 104 and/or the fraud detection system 106.

In some aspects, the functions performed by components/modules of the risk rule generation system 108 are associated with one or more applications, services, or routines. In particular, such applications, services, or routines may operate on one or more user devices, servers, may be distributed across one or more user devices and servers, or be implemented in the cloud. Moreover, in some aspects, the components/modules of the risk rule generation system 108 may be distributed across a network, including one or more servers and client devices, in the cloud, and/or may reside on a user device. Moreover, these components/modules, functions performed by these components/modules, or services carried out by these components/modules may be implemented at appropriate abstraction layer(s) such as the operating system layer, application layer, hardware layer, etc., of the computing system(s). Alternatively, or in addition, the functionality of these components/modules and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The risk rule generation system 108 leverages metadata from a metadata store 120 to power automated pipelines that identify fraudulent trends in online transactions on the online transaction platform 104, generate risk rules based on the fraudulent trends, and deploy the risk rules in the fraud detection system 106. This enables the near real-time identification and mitigation of fraudulent activities, thereby ensuring improved security and efficiency. For instance, the automated end-to-end pipeline provided by the risk rule generation system 108 can identify and create risk rules to block real-time fraudulent trends within a short period of time, thereby quickly mitigating potential financial losses.

The metadata store 120 is a repository that stores and manages metadata employed by the pipelines of the risk rule generation system 108. This metadata store 120 ensures that aspects of the risk rule generation system 108, from data collection and fraud trend detection to rule generation and deployment, are supported by well-organized and accessible metadata. By way of example only and not limitation, the metadata can include:
Event Message Metadata and Data Processing Configuration: Facilitates data collection by defining how data is processed and managed.
Fraud Detection Parameters: Contains definitions for abnormality metrics, similarity checking thresholds, and transaction query time ranges, which provide for identifying fraudulent activities.
Rule Generation Support: Dataset metadata used for querying data used in rule training and tuning.
Performance Evaluation Metrics: Provide metrics for assessing system performance, ensuring that the platform operates efficiently.
Rule Simulation Execution Parameters: Include parameters that guide the execution of rule simulations, ensuring their accuracy and effectiveness.
Rule Deployment Configurations: Provide definitions for online performance evaluation metrics and configurations used for deploying rules in the production environment.

As will be described in further detail, the components of the risk rule generation system 108 execute automated pipelines that leverage metadata from the metadata store 120 to provide an automated end-to-end process for automatic rule generation and deployment in the fraud detection system 106. Initially, the data collection module 112 ingests event data related to transactions on the online transaction platform 104, which can include real-time or near real-time data as generated by the online transaction platform 104 and/or the fraud detection system 106. The event data can include, for instance, transaction data providing details of transactions on the online transaction platform, such as information regarding the accounts used and payment processing information. The event data can also include data from risk evaluation logs, which record data regarding risk assessments performed by the fraud detection system 106 for transactions on the online transaction platform 104. The event data can further include transaction feedback data providing information such as payment disputes, chargebacks, customer service contacts, and user reviews for transactions on the online transaction platform 104.

The data collection module 112 employs metadata from the metadata store 120 to determine the type of event data to collect. The data collection module 112 also enriches the collected data with relevant metadata to provide enriched data for downstream processing. In some configurations, the enriched data is published to a message queue, such as Kafka, and the data is also stored in offline data warehouses for subsequent analysis and fraud detection.

In accordance with some aspects, the data collection module 112 is designed to be dynamic and configurable via the metadata defined in the metadata store 120. For instance, the metadata-driven approach allows for the subscription to new events and messages without requiring code changes. Instead, configuration changes can be made to the metadata to update the events and messages consumed by the system and how the event data is enriched, making the process more efficient and adaptable to evolving data sources.

The fraudulent trend detection module 114 analyzes enriched data collected by the data collection module 112 to identify trends in fraudulent activity on the online transaction platform 104 that are used by downstream processes to generate and deploy risk rules. In some aspects, the fraudulent trend detection module 114 identifies abnormal transactions and normal transactions. For instance, the fraudulent trend detection module 114 can leverage abnormal transaction definitions from the metadata store 120 to identify abnormal transactions in transaction data. In some aspects, the fraudulent trend detection module 114 can also leverage feedback data (e.g., payment disputes, chargebacks, customer service contacts, user reviews, etc.) and/or risk evaluation log data to identify the abnormal transactions. The fraudulent trend detection module 114 can also identify normal transactions using normal transaction definitions in the metadata store 120. To enhance data volume, similar abnormal transactions within a given time range are also identified using similarity thresholds specified in the metadata store 120.

The fraudulent trend detection module 114 uses data for the abnormal transactions and the normal transactions to calculate business metrics and fraudulent labels in accordance with metrics and labels definitions in the metadata store 120. The fraudulent trend detection module 114 then applies clustering and/or predictive algorithms to identify trends among fraudulent transactions, which inform subsequent rule generation. Algorithm parameters and abnormality score thresholds used for the clustering and predictive algorithms can be specified by metadata in the metadata store. By leveraging advanced algorithms and comprehensive metadata, the fraudulent trend detection module 114 ensures accurate and timely detection of fraudulent trends, thereby enhancing the overall security and efficiency of the fraud detection system 106.

The rule generation module 116 is triggered by fraud trend detection results from the fraudulent trend detection module 114. The rule generation module 116 is responsible for creating risk rules that can effectively identify and mitigate fraudulent transactions based on the fraudulent trends. The rule generation module 116 can also evaluate the generated risk rules.

In some configurations, the rule generation module 116 leverages metadata from the metadata store 120 to perform a number of tasks to generate risk rules, including reference dataset creation and labeling, variable selection, rule construction, risk rule simulation, and performance evaluation. For instance, when triggered, the rule generation module 116 can retrieve transaction data and calculate related fraudulent labels for the data. The rule generation module 116 analyzes labeled data to select key variables for rule creation, for instance using statistical methods and algorithms. The rule generation module 116 then generates risk rules by tuning variable thresholds to maximize decision precision, aiming to identify as many fraudulent transactions as possible while not identifying normal transactions as fraudulent. To evaluate the generated risk rules, the rule generation module 116 simulates execution of the risk rules using a prepared data, and performance of the risk rules is evaluated and validated before deployment.

Given risk rules from the rule generation module 116, the rule deployment module 118 deploys the risk rules to the fraud detection system 106. Once deployed, the generated risk rules are used by the fraud detection system 106 to identify fraudulent transactions on the online transaction platform 104 and to take actions for the fraudulent transactions.

In some aspects, the rule deployment module 118 can deploy the risk rules in different modes. For instance, in some configurations, the risk rules are initially deployed in a flagging mode, in which the risk rules are used to flag transactions that are deemed to be fraudulent based on the rules, but no automatic blocking action is performed by the system. This gives the system an opportunity to assess the performance of the risk rules for live transactions to ensure the risk rules effectively identify fraudulent transactions while limiting false positives. The evaluation can be performed using metadata specified by the metadata store 120. If the risks rules are validated, the risk rules can be moved from the flagging mode to an active mode, in which the system actively blocks transactions identified as fraudulent by the risk rules. The system can continue monitor performance of the risk rules to identify any issues. If the risk rules are not validated while in the flagging mode, they can be deprecated. In further configurations, the risk rules can be deployed in an active mode without an initial flagging mode.

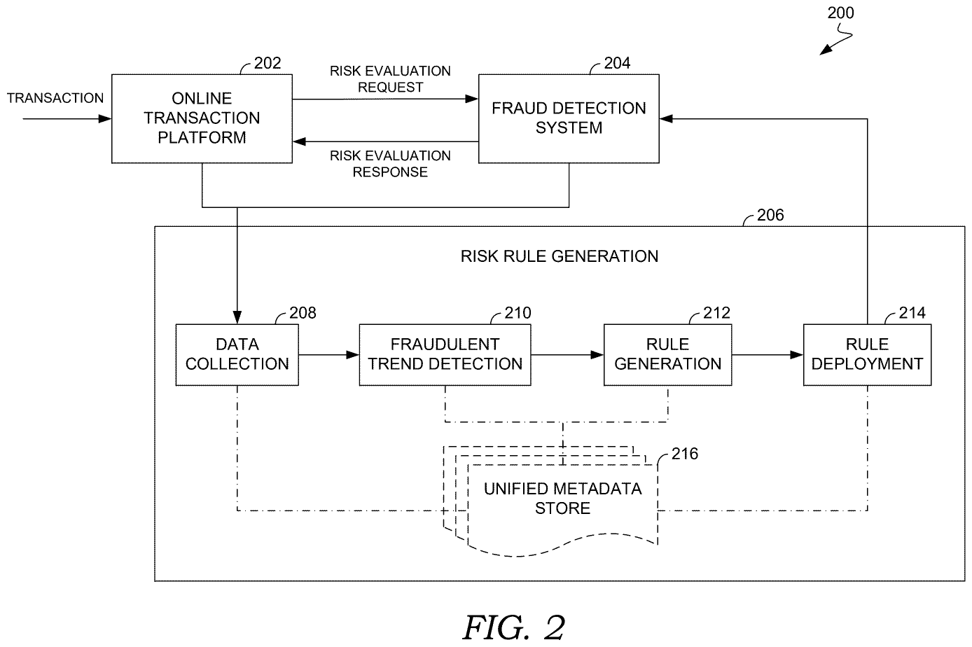

Turning next to FIG. 2, a block diagram is provided that illustrates an overall workflow 200 in accordance with some aspects of the present technology. The workflow 200 includes a fraud detection system 204 (which can correspond to the fraud detection system 106 of FIG. 1) that uses risk rules to evaluate transactions on an online transaction platform 202 (which can correspond to the online transaction platform 104 of FIG. 1). The workflow 200 also includes an end-to-end pipeline 206 for automatic risk rule generation and deployment (e.g., as performed by the risk rule generation system 108 of FIG. 1) that leverages metadata from a metadata store 216 (which can correspond to the metadata store 120 of FIG. 1).

The end-to-end pipeline 206 is provided by a series of pipelines, including a data collection pipeline 208, a fraudulent trend detection pipeline 210, a rule generation pipeline 212, and a rule deployment pipeline 214. Based on event metadata from the metadata store 216, the data collection pipeline 208 collects event data from the online transaction platform 202 and the fraud detection system 204. The event data can include, for instance, transaction data regarding transactions performed on the online transaction platform 202, transaction feedback data received for any of those transactions, and risk evaluation data provided by the fraud detection system 204 for those transaction. The online transaction platform 202 can also enrich the collected data with metadata based on the metadata store.

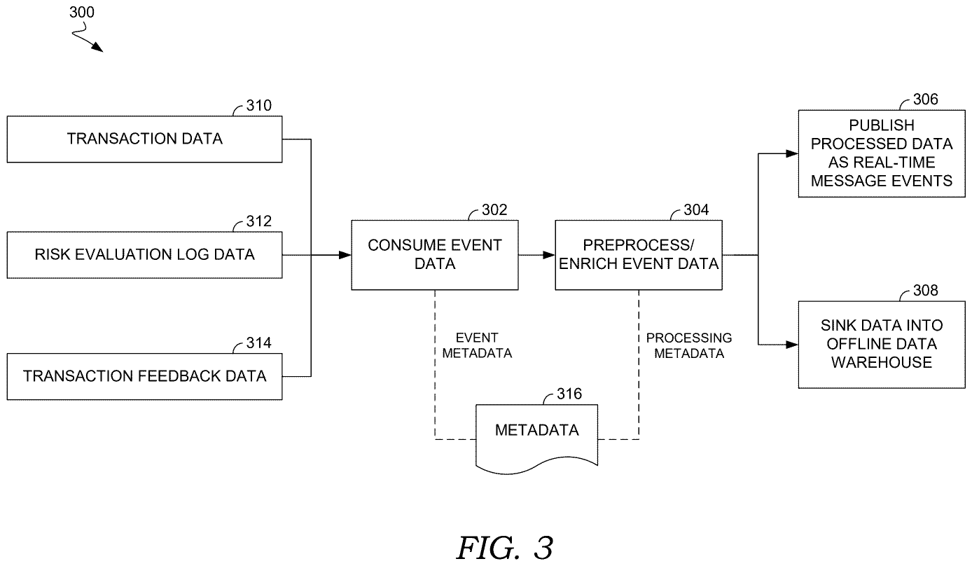

Using data collected by the data collection pipeline 208, the fraudulent trend detection pipeline 210 leverages metadata from the metadata store 216 to identify fraudulent and normal transactions and analyzes the transactions to identify fraudulent trends/patterns. Based on the identified fraudulent trends, the rule generation pipeline 212 leverages metadata from the metadata store 216 to generate risk rules. The rule deployment pipeline 214 then employs metadata from the metadata store 216 to deploy the risk rules, if validated, to the fraud detection system 204. Examples of each of these pipelines is provided with further detail in FIGS. 3-6.

FIG. 3 provides a block diagram illustrating an example data collection pipeline 300 used by a data collection module, such the data collection module 112 of FIG. 1, to collect event data and enrich the event data using metadata from a metadata store 316 (which can correspond to the metadata store 120 of FIG. 1). The data collection pipeline 300 begins by consuming event data, as shown at block 302. As shown in FIG. 3, the event data can include transaction data 310, risk evaluation log data 312, and transaction feedback data 314. The event data can be consumed from real-time or near real-time events and messages from various sources, such as transaction processing systems and fraud detection systems. The consumption of event data is governed by event metadata provided by the metadata store 316. This event metadata specifies the types of event data to consume and the data points or attributes encapsulated in these events.

Once the events are consumed, the event data is preprocessed and enriched using relevant metadata, as shown at block 304. This preprocessing is governed by processing metadata from the metadata store 316. The processing metadata specifies how the event data is initially pre-processed and managed. In some aspects, this can also involve querying external services, such as user information services and payment instrument services, to obtain additional data points, as specified by the processing metadata. It can also include transforming or calculating certain attributes in the event data based on the processing metadata. This converts the event data into enriched data, making the data usable for subsequent dynamic analysis.

After preprocessing and enrichment of the event data, the enriched data is published as real-time message events to a message queue, such as Kafka, as shown at block 306. This ensures that the data is available for immediate analysis and fraud trend detection. In addition to publishing real-time message events, the enriched data is also stored in offline data warehouses for subsequent analysis and fraud detection, as shown at block 308. This allows for comprehensive analysis of historical data and supports the generation of risk rules.

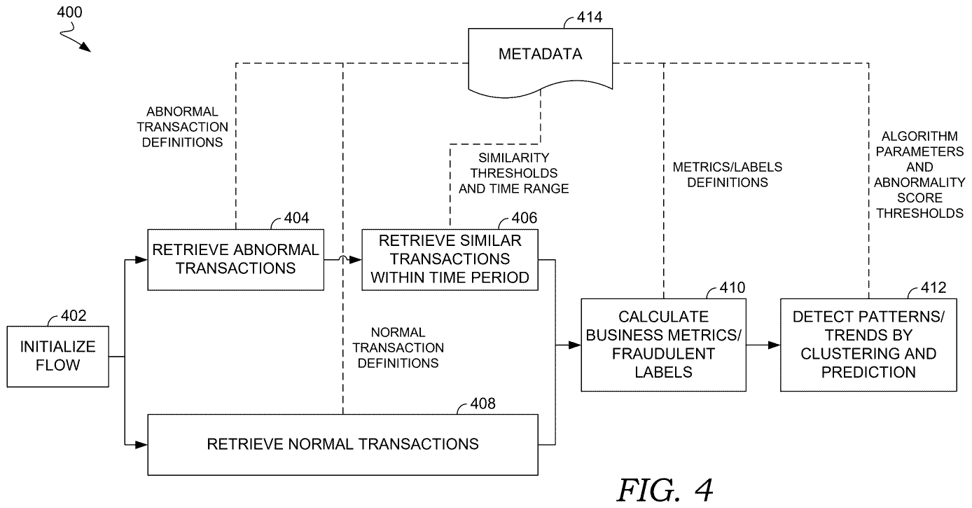

FIG. 4 provides a block diagram illustrating an example fraudulent trend detection pipeline 400 used by a fraudulent trend detection module, such the fraudulent trend detection module 114 of FIG. 1, to analyze collected event data and detect trends in abnormal transaction activities using metadata from a metadata store 414 (which can correspond to the metadata store 120 of FIG. 1). The fraudulent trend detection pipeline 400 begins with the initialization of the fraudulent trend detection flow, as shown at block 402. This can involve setting up the necessary configurations and parameters for detecting fraudulent trends using enriched data, for instance, from the data collection pipeline 300.

The system extracts data for abnormal transactions from the enriched data, as shown at block 404. The abnormal transactions can be identified based on abnormal transaction definitions provided by a metadata store 414 (which can correspond to the metadata store 120 of FIG. 1). In some aspects, the abnormal transaction definitions can be used to analyze feedback-related data to identify abnormal transactions. The feedback-related data can include, for instance, information from payment disputes, chargebacks, customer service contacts, user reviews, or other types of user-feedback information that is indicative of abnormal transactions.

To enhance data volume, the fraudulent trend detection pipeline 400 also retrieves data for similar abnormal transactions within a specified time period, as shown at block 406. This can involve using similarity thresholds and a time range specified by the metadata store 414 to identify transactions that share similar characteristics with the abnormal transactions initially detected at block 404.

The fraudulent trend detection pipeline 400 also retrieves data for normal transactions from the enriched data, as shown at block 408. The normal transactions can be identified based on normal transaction definitions provided by the metadata store 414. The normal transactions can be used as a baseline to compare against the abnormal transactions in subsequent steps.

Using the data for the abnormal transactions and the normal transactions, the fraudulent trend detection pipeline 400 calculates business metrics and fraudulent labels, as shown at block 410. This involves analyzing the collected data using metrics and label definitions provided by the metadata store 414 to determine the business metrics and fraudulent labels to employ for the collected data.

The fraudulent trend detection pipeline 400 next employs clustering and predictive algorithms to detect common trends/patterns among the fraudulent transactions, as shown at block 412. These algorithms analyze the relationships between various transaction attributes and identify clusters of similar fraudulent activities. This is guided by algorithm parameters and abnormality score thresholds provided by the metadata store 414.

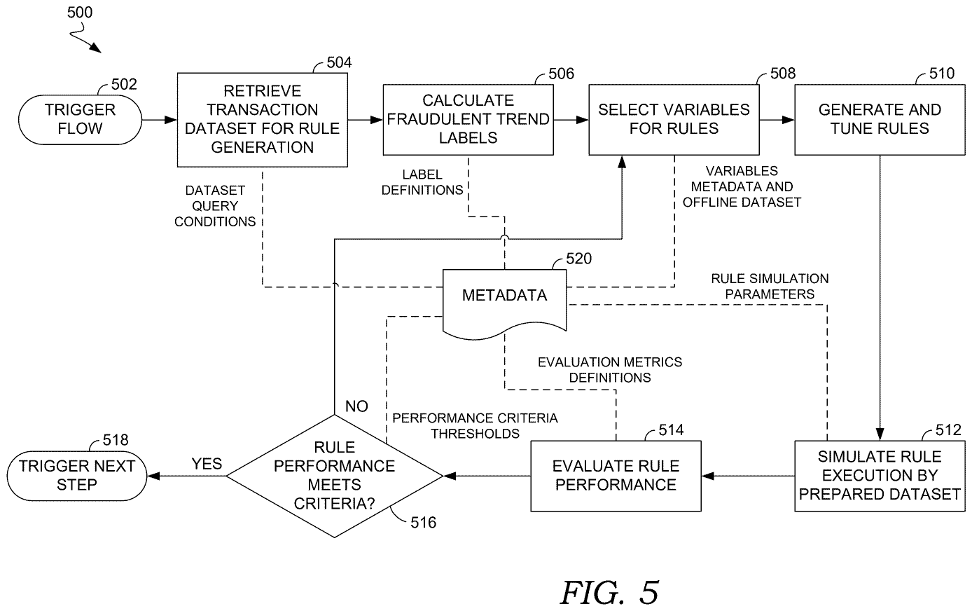

FIG. 5 provides a block diagram illustrating an example rule generation pipeline 500 used by a rule generation module, such the rule generation module 116 of FIG. 1, to create and evaluate risk rules based on identified fraudulent trends and metadata from a metadata store 520 (which can correspond to the metadata store 120 of FIG. 1). The rule generation pipeline 500 begins with the initiation of the rule generation flow at block 502, for instance, triggered by the detection of fraudulent trends by a fraud trend detection module (e.g., via the fraudulent trend detection pipeline 400). Transaction data is retrieved for rule generation, as shown at block 504. The transaction data can be retrieved based on identified fraudulent trends and by leveraging query condition metadata provided by the metadata store 520.

The rule generation pipeline 500 next involves calculating fraudulent trend labels for the retrieved transaction action data using label definitions from the metadata store, as shown at block 506. This can include, for instance, assigning labels to the transactions based on their likelihood of being fraudulent and/or their fraudulent nature. Key variables are selected for rule generation at block 508. For instance, using statistical methods and algorithms on the labeled transaction data, as well as variables metadata specified by the metadata store 520, the rule generation pipeline 500 identifies key variables based on their relevance to identifying fraudulent transactions. Rules are generated at block 510 by tuning variable thresholds to maximize decision precision. This can involve setting conditions for the selected variables, such as specific value ranges, to create risk rules that can accurately identify fraudulent transactions based on the fraudulent trends.

The rule generation pipeline 500 also includes steps for evaluating the generated risk rules. As shown in FIG. 5, execution of the risk rules is simulated using a prepared dataset, as shown at block 512. This step involves running the risk rules on the dataset to check whether the risk rules can effectively identify fraudulent transactions without impacting normal transactions. The process can employ rule simulation parameters from the metadata store 520 for the simulations. Performance of the risk rules is then evaluated at block 514 using evaluation metrics definitions, such as precision and recall rates, provided by the metadata store 520. These evaluation metrics are used to assess the accuracy and effectiveness of the risk rules in identifying fraudulent transactions while not impacting normal transactions. A determination is made at block 516 regarding whether performance criteria thresholds provided by the metadata store 520 are satisfied. If the risk rules meet the performance criteria thresholds, the rule generation pipeline 500 proceeds to the next step (i.e., rule deployment), as shown at block 518. Alternatively, if the performance criteria thresholds are not met, the system can iterate through the rule generation process again to improve the risk rules. This process can be repeated until the performance criteria thresholds are met. In some configurations, if the performance criteria thresholds are not met in one or more iterations, the risk rules can be discarded.

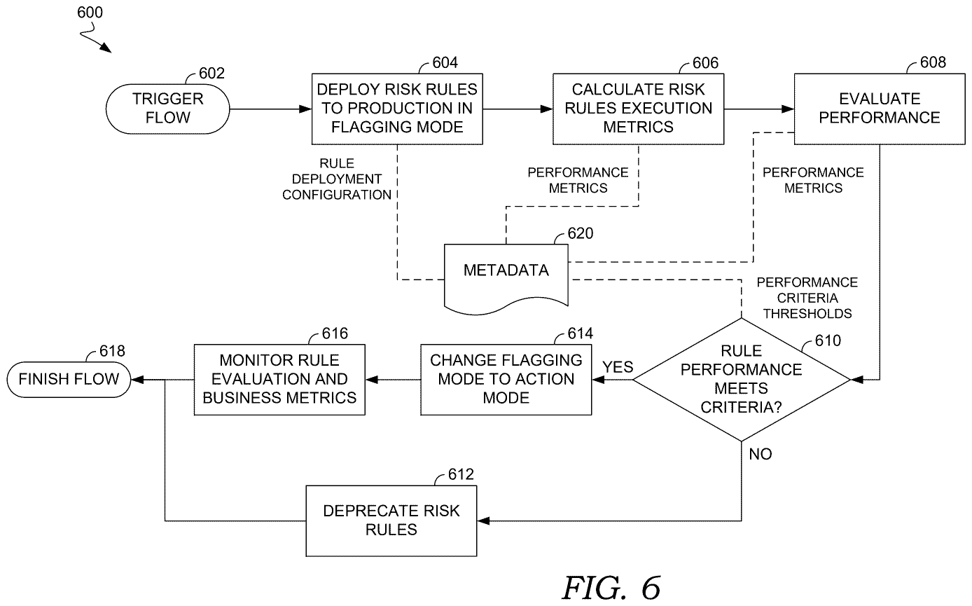

FIG. 6 provides a block diagram illustrating an example rule deployment pipeline 600 used by a rule deployment module, such the rule deployment module 118 of FIG. 1, to deploy risk rules in a risk evaluation component, such as the fraud detection system 106 of FIG. 1. This process is guided by metadata from a metadata store 620 (which can correspond to the metadata store 120 of FIG. 1). The rule deployment pipeline 600 begins with the initiation of the rule deployment flow at block 602, for instance, triggered by the successful generation and validation of risk rules by a rule generation module (e.g., via the rule generation pipeline 500).

In the configuration of FIG. 6, the risk rules are initially deployed in a flagging mode, as shown at block 604, in accordance with a rule deployment configuration specified by the metadata store 620. In the flagging mode, the risk rules are applied in the production environment to flag potentially fraudulent transactions without taking any blocking actions. This allows for the evaluation of the rules' performance in the production environment without impacting legitimate transactions.

After the risk rules have been deployed in the flagging mode, the rule deployment pipeline 600 calculates execution metrics for the risk rules using performance metrics metadata provided by the metadata store 620, as shown at block 606. The execution metrics include, for instance, the number of flagged transactions and the accuracy of the flags. These metrics facilitate further analysis to determine whether the risk rules are functioning as expected. In particular, the execution metrics from the flagging mode are used to evaluate the performance of the risk rules at block 608 based on predefined criteria, such as precision, recall, and business impact, as defined by metadata from the metadata store 620. This evaluation helps determine whether the risk rules are effective in identifying fraudulent transactions in the production environment without causing false positives.

A determination is made at block 610 regarding whether performance criteria thresholds provided by the metadata store 620 are satisfied. If the performance criteria thresholds are not met at block 610, the system can deprecate the risk rules, and the changes are discarded, as shown at block 612. This ensures that only effective risk rules are deployed in the production environment. Alternatively, if the risk rules meet the performance criteria thresholds, the risk rules are changed from the flagging mode to an action mode in which the risk rules are used to not only identify but also actively block fraudulent transactions, as shown at block 614. In some aspects, the system continuously monitors the performance of the risk rules in the active mode in the production environment and their impact on business metrics, as shown at block 616. This ongoing monitoring ensures that any issues with the risk rules are quickly identified and addressed. After either placing the risk rules in action mode or deprecating the risk rules, the rule deployment pipeline 600 ends at block 618.

### Example Method for Metadata-Driven Risk Rule Generation and Deployment

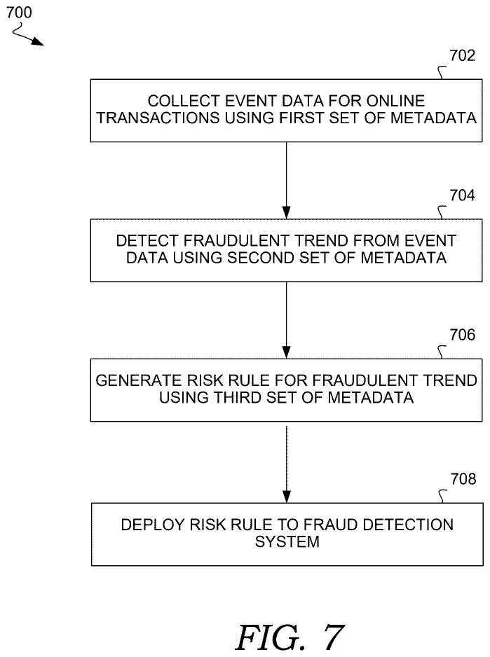

With reference now to FIG. 7, a flow diagram is provided that illustrates a method 700 for metadata-driven risk rule generation and deployment. The method 700 can be performed, for instance, by components of the fraud detection system 106 of FIG. 1. Each block of the method 700 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 702, event data is collected for online transactions on an online transaction platform. The event data is collected using a first set of metadata from a metadata store (such as the metadata store 120 of FIG. 1). The first set of metadata can include, for instance, event metadata that specifies the type of event data to collect, and/or processing metadata for enriching the event data. The event data can include, for instance, transaction data, feedback-related data, and/or risk evaluation log data from the online transaction platform and/or from a fraud detection system used to detect fraudulent transactions on the online transaction platform.

The event data is processed to detect a fraudulent trend, as shown at block 704. The fraudulent trend detection is guided by a second set of metadata from the metadata store. In some aspects, the fraudulent trend detection process includes using abnormal transaction definitions and normal transaction definitions in the second set of metadata to identify a first subset of the online transactions as abnormal transactions and a second subset of the online transactions as normal transactions. This can include leveraging feedback-related data and/or risk evaluation log data in conjunction with the abnormal transaction definitions to identify the abnormal transactions. The abnormal transactions and normal transactions can then be analyzed using clustering and/or predictive algorithms guided by metadata from the second set of metadata to detect the fraudulent trend.

As shown at block 706, a risk rule is generated for the fraudulent trend. This risk rule generation is guided by a third set of metadata from the metadata store. In some aspects, the risk rule generation process includes sampling transaction data based on the fraudulent trend and using metadata from the third set of data to select one or more variables for rule creation based on the sampled transaction data. The risk rule can then be generated by tuning a variable threshold for each of the one or more variables. In some aspects, the process can also include an offline evaluation of the risk rule using a simulation dataset. This can include, for instance, simulating execution of the risk rule using a simulation dataset, followed by evaluating performance of the simulated execution using metadata from the first set of metadata.

After generating the risk rule (and optionally performing an offline assessment of the risk rule), the risk rule is deployed to a fraud detection system for the online transaction platform, as shown at block 708. In some instances, the risk rule can be deployed to the fraud detection system in an active mode without any further evaluation. In other instances, the risk rule is initially deployed to the fraud detection system in a flagging mode in which the risk rule is only used to flag fraudulent transactions without taking an active step to block those transactions. This allows for a period of time in which the performance of the risk rule in the production environment is assessed without negatively impacting transactions (e.g., blocking false positives). The performance evaluation can be guided by a fourth set of metadata. Responsive to the performance evaluation meeting performance criteria from the fourth set of metadata, the risk rule is deployed to the fraud detection system in an action mode for blocking fraudulent transactions on the online transaction platform.

### Exemplary Operating Environment

Having described implementations of the present disclosure, an exemplary operating environment in which embodiments of the present technology can be implemented is described below in order to provide a general context for various aspects of the present disclosure. Referring initially to FIG. 8 in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what can be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory can be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which can be built in. Illustrative components include a microphone, joystick, game pad, satellite dish, scanner, printer, wireless device, etc. The I/O components 820 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 can be equipped with depth cameras, such as, stereoscopic camera systems, infrared camera systems, RGB camera systems, and combinations of these for gesture detection and recognition. Additionally, the computing device 800 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
collecting event data related to a plurality of online transactions on an online transaction platform, wherein the event data is collected and enriched using a first set of metadata from a metadata store to provide enriched data;
detecting a fraudulent trend by analyzing the enriched data using one or more clustering and/or predictive algorithms guided by a second set of metadata from the metadata store;
generating a risk rule based on the fraudulent trend using a third set of metadata from the metadata store; and
deploying the risk rule to an online fraud detection system to identify fraudulent transactions on the online transaction platform.

2. The one or more computer storage media of claim 1, wherein the event data is collected based on event metadata from the metadata store that specifies types of event data to collect.

3. The one or more computer storage media of claim 1, wherein the event data related to the plurality of online transactions comprises transaction data and feedback-related data.

4. The one or more computer storage media of claim 3, wherein detecting the fraudulent trend comprises:
identifying, using one or more abnormal transaction definitions in the metadata store and the feedback-related data, a first subset of the plurality of online transactions as abnormal transactions; and
identifying, using one or more normal transaction definitions in the metadata store, a second subset of the plurality of online transactions as normal transactions.

5. The one or more computer storage media of claim 4, wherein detecting the fraudulent trend further comprises:
calculating metrics and labels for the enriched data by applying metrics and label definitions from the metadata store to the enriched data for the abnormal transactions and the normal transactions, wherein the one or more clustering and/or predictive algorithms are applied to the enriched data with the metrics and the labels to detect the fraudulent trend.

6. The one or more computer storage media of claim 1, wherein generating the risk rule comprises:
sampling transaction data based on the fraudulent trend;
selecting, using variables metadata from the metadata store, one or more variables for rule creation based on the sampled transaction data; and
generating the risk rule by tuning a variable threshold for each of the one or more variables.

7. The one or more computer storage media of claim 1, wherein the operations further comprise:
simulating execution of the risk rule using a simulation dataset; and
evaluating performance of the simulated execution of the risk rule using one or more evaluation metric definitions from the metadata store, wherein the risk rule is deployed to the online fraud detection system in response to the performance of the simulated execution of the risk rule meeting one or more performance criteria from the metadata store.

8. The one or more computer storage media of claim 1, wherein deploying the risk rule to the online fraud detection system comprises:
deploying the risk rule to the online fraud detection system in a flagging mode for performance evaluation; and
responsive to the performance evaluation meeting one or more performance criteria from the metadata store, deploying the risk rule to the online fraud detection system in an action mode for blocking fraudulent transactions on the online transaction platform.

9. A computer-implemented method comprising:
performing a data collection pipeline using a first set of metadata from a metadata store to collect event data for a plurality of online transactions from an online transaction platform and a fraud detection system for the online transaction platform;
performing a fraudulent trend detection pipeline using a second set of metadata from the metadata store to detect a fraudulent trend in the event data;
performing a rule generation pipeline using a third set of metadata from the metadata store to generate a risk rule for the fraudulent trend; and
deploying the risk rule in the fraud detection system.

10. The computer-implemented method of claim 9, wherein performing the data collection pipeline comprises:
collecting the event data based on event metadata specifying data types to collect; and
enriching the event data with processing metadata.

11. The computer-implemented method of claim 9, wherein performing the fraudulent trend detection pipeline comprises:
identifying, using one or more abnormal transaction definitions and feedback-related data, a first subset of the plurality of online transactions as abnormal transactions;
identifying, using one or more normal transaction definitions in the metadata store, a second subset of the plurality of online transactions as normal transactions; and
performing one or more clustering and/or predictive algorithms using data from the abnormal transactions and the normal transactions to detect the fraudulent trend.

12. The computer-implemented method of claim 9, wherein performing the rule generation pipeline comprises:
sampling transaction data based on the fraudulent trend;
selecting, using variables metadata from the metadata store, one or more variables for rule creation based on the sampled transaction data; and
generating the risk rule by tuning a variable threshold for each of the one or more variables.

13. The computer-implemented method of claim 9, wherein performing the rule generation pipeline comprises:
simulating execution of the risk rule using a simulation dataset; and
evaluating performance of the simulated execution of the risk rule using one or more evaluation metric definitions from the metadata store, wherein the risk rule is deployed to the fraud detection system in response to the performance of the simulated execution of the risk rule meeting one or more performance criteria from the metadata store.

14. The computer-implemented method of claim 9, wherein deploying the risk rule to the fraud detection system comprises performing a rule deployment pipeline using a fourth set of metadata from the metadata store.

15. The computer-implemented method of claim 14, wherein performing the rule deployment pipeline comprises:
deploying the risk rule to the fraud detection system in a flagging mode for performance evaluation; and
responsive to the performance evaluation meeting one or more performance criteria from the metadata store, deploying the risk rule to the fraud detection system in an action mode for blocking fraudulent transactions on the online transaction platform.

16. A computer system comprising:
a processor; and
a computer storage medium storing computer-useable instructions that, when used by the processor, causes the computer system to perform operations comprising:
accessing event data for a plurality of online transactions on an online transaction platform based a first set of metadata from a metadata store;
detecting a fraudulent trend by employing a second set of metadata from the metadata store to identify abnormal transactions in the plurality of online transactions and to identify the fraudulent trend by applying one or more clustering and/or predictive algorithms to event data for the abnormal transactions;
generating a risk rule by employing a third set of metadata from the metadata store to select one or more variables and a variable threshold for each variable based on the fraudulent trend; and
deploying the risk rule to an online fraud detection system to identify fraudulent transactions on the online transaction platform.

17. The computer system of claim 16, wherein the abnormal transactions are identified using abnormal transaction definitions in the second set of metadata to analyze feedback-related data associated with at least a portion of the plurality of online transactions.

18. The computer system of claim 17, wherein the fraudulent trend is detected by further using normal transaction definitions in the second set of metadata to identify normal transactions in the plurality of online transactions and applying the one or more clustering and/or predictive algorithms to event data for the normal transactions.

19. The computer system of claim 16, wherein the operations further comprise:
simulating execution of the risk rule using a simulation dataset; and
evaluating performance of the simulated execution of the risk rule using one or more evaluation metric definitions from the metadata store, wherein the risk rule is deployed to the online fraud detection system in response to the performance of the simulated execution of the risk rule meeting one or more performance criteria from the metadata store.

20. The computer system of claim 16, wherein deploying the risk rule to the online fraud detection system comprises:
deploying the risk rule to the online fraud detection system in a flagging mode for performance evaluation; and
responsive to the performance evaluation meeting one or more performance criteria from the metadata store, deploying the risk rule to the online fraud detection system in an action mode for blocking fraudulent transactions on the online transaction platform.
